(19) United States
(12) Patent Application Publication
(10) Pub. No.: US 2002/0009703 A1
(43) Pub. Date: Jan. 24, 2002

(54) Two sided writing board

(76) Inventor: Mike C. Owen, S. Lake Tahoe, CA (US)

Correspondence Address: Rodger Flagg, Patent Agent, 2121 Eisenhower Ave., Suite 500, Alexandria, VA, 22314, US

(21) Appl. No.: 09/858,499

(22) Filed: May 17, 2001

Related U.S. Application Data
(60) Provisional application No. 60/204,781, filed on May 17, 2000.

(51) Int. Cl. B43L 1/00

(52) U.S. Cl. 434/408

(57) ABSTRACT

This invention discloses of a portable, lightweight dry erase board having a central foam core coated on first and second opposing sides with a dry erase surface. The dry erase board has a lightweight frame covering the external edge surface, for strength and durability. The frame includes a top frame portion, a bottom frame portion and opposing first and second side frame portions. The bottom frame portion has an enlarged external bottom surface suitable for supporting the dry erase board on a horizontal planar surface, such as a counter or table. Mounting clips may also be supported from the top frame portion, for hanging the dry erase board on a wall, or from above. A marker tray is releasably secured to the bottom frame portion with clips. The marker tray is easily removable, for mounting on either the first or second side of the dry erase board. A pliable cover is provided for ease of transport and storage.

### BACKGROUND OF THE INVENTION

1. Filed of the Invention

White boards, or dry erase boards have become standard features in schools, homes and offices around the world. Unlike chalkboards, these writing boards have a white surface. Colored dry, erasable markers are used to write on the surface of the dry erase board instead of the well-known white chalk used on chalkboards. Because of the surface material applied to the core, these boards can be easily erased, for reuse. White boards are made in a variety of sizes. Some cover entire walls. Others can be carried to meetings as needed.

2. Description of the Prior Art

Examples of white boards are found in various U.S. Patents. U.S. Pat. No. 4,828,502 to Leahy discloses a dry erase board that is concealed behind a pair of doors, or an artwork. In one example, Leahy has a hinged board that when closed is one-half size. Artwork is located on the back of the outer board. When the board is opened, the artwork is concealed and the board becomes a full-width writing surface. In another embodiment, Leahy discloses a full-width board concealed behind a pair of cabinet-like doors. When the doors are opened the white board is exposed for use. This type of board is designed for permanent mounting and is limited to the writing surface of the full-opened unit.

U.S. Pat. No. 5,727,952 to Schenck et al. discloses a porcelain-coated steel surface that is set within a frame. The lower part of the frame has a horizontal ledge that holds pens and erasers. Again, the writing surface is limited to the front of the board.

U.S. Pat. No. 5,163,845 discloses a portable writing surface. This unit has a carrying case that holds a chalkboard. When in use, the chalkboard is placed in a frame holder formed in the unit. The back of the unit has pockets for storing small items. The device has a foot that allows it to be freestanding. Although this unit is portable, it is still restricted to one writing surface.

U.S. Pat. No. 5,176,522 to Robertson, Jr. discloses a single sides white board that is mounted in a rigid frame. The frame is made of extruded aluminum, which is then angled to fit around the board. A ledge fits one the bottom of the board. The frame is secured at the corners with clips. The clips can also be used to hang the board, if desired. The lower ledge acts as a holding tray for pens and erasers.

U.S. Pat. No. 5,035,626 to Persing discloses another single-sided marker board that has a frame that fits around the writing surface but does not overlap the surface.

U.S. Pat. No. 4,834,334 to Robins discloses a tilt and turn easel. This device has a rectangular base and a vertical frame. The vertical frame holds two writing surfaces: a chalkboard on one side and a dry erase board on the other. The vertical frame is mounted on pivots that allow the frame to be tilted. Thus, one side can be used for writing. As desired, the device can be turned around and flipped back to allow the other surface to be used. Although the device allows for writing on two sides, it requires a desk or table to support it. Moreover, it also requires that the user turn the device completely around and to tilt the frame in the opposite direction for use.

U.S. Pat. No. 5,941,713 to Wayner et al. discloses a mobile display board. This device has a wheeled base that supports two writing boards. These boards are coated metal. The device includes a storage area in the base. Trays are provided to hold pens and other accessories. Because the boards are metal, magnetic strips are provided to hold notes or other items on the display boards, as desired.

White boards are typically made of metal or other materials having a smooth planar surface, such as fiberboard. One example of white board construction is found in U.S. Pat. No. 3,949,132 to Seregely et al. Seregely discloses a dry erase board that has a smooth, hard, non-porous plastic surface, such as polypropylene, polyethylene, polystyrene, or polyvinylchloride.

To date, white boards have been treated on only one side. Thus, only one side of the board is available for writing. This has not been too much of a problem because the boards can be erased, following use. Of course, if a small board is used in a meeting, for example, this limits the ability to save information written on the board.

### SUMMARY OF THE INVENTION

This invention relates of a portable, lightweight dry erase board having a central foam core coated on first and second opposing sides with a dry erase surface. The dry erase board has a lightweight frame covering the external edge surface, for strength and durability. The frame includes a top frame portion, a bottom frame portion and opposing first and second side frame portions. The bottom frame portion has an enlarged external bottom surface suitable for supporting the dry erase board on a horizontal planar surface, such as a counter or table. Mounting clips may also be supported from the top frame portion, for hanging the dry erase board from above. A marker tray is releasably secured to the bottom frame portion with clips. The marker tray is easily removable, for mounting on either the first or second side of the dry erase board. . A pliable cover is provided for ease of transport and storage.

The above and other objects, features and advantages of the present invention will become more apparent from the following description when taken in conjunction with the accompanying drawings in which a preferred embodiment of the present invention is shown by way of an illustrative example.

### BRIEF DESCRIPTION OF THE DRAWINGS

FIG. 1 is a perspective view of the invention, showing the first side of the dry erase board with the frame mounting clips and marker tray installed.

FIG. 2 is a cross sectional view of the dry erase board, taken along lines 22 in FIG. 1.

FIG. 3 is a cross sectional view of the marker tray and bottom frame portion, taken along lines 3-3 in FIG. 1.

FIG. 4 is a cross sectional view of the top frame portion with frame mounting clips installed, taken along lines 4-4 in FIG. 1.

FIG. 5 is a perspective view of a pliable cover for the dry erase board apparatus, having a handle and an opening sized to pass the dry erase board apparatus therethrough.

### DETAILED DESCRIPTION OF THE INVENTION

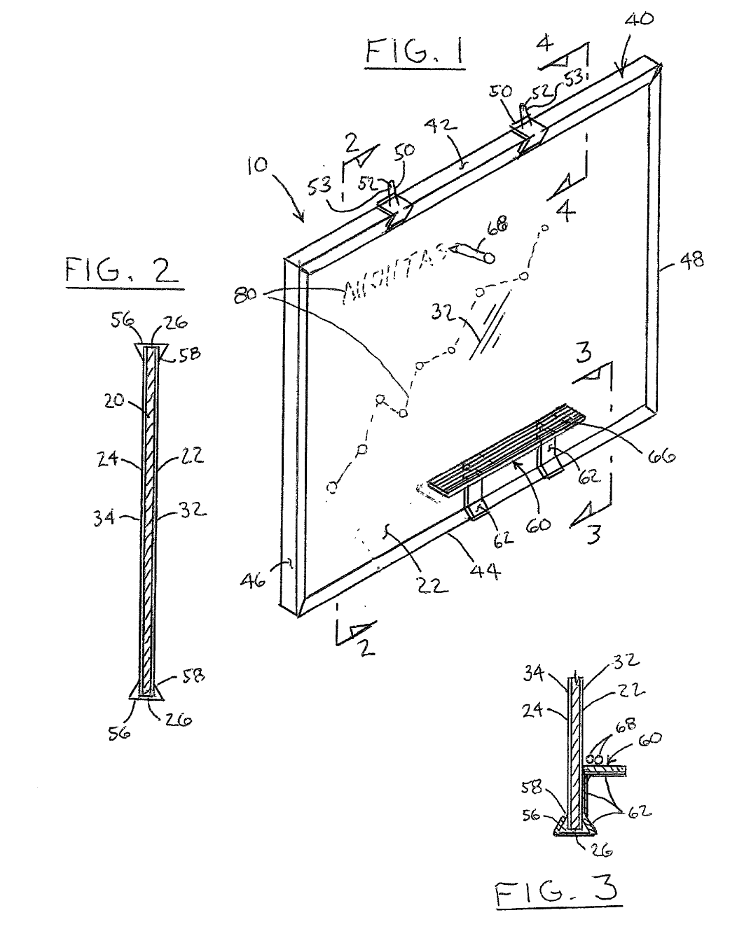

As shown in FIG. 1 and FIG. 2, this invention discloses a lightweight foam core board 20 having a thin cross sectional profile, which is coated on both the first side 22 and the second side 24, with first and second dry erase poly-film layers 32, 34. This produces a thin, very lightweight two sided dry erase board apparatus 10, even when made in relative large sizes. In one preferred embodiment, the size of the dry erase board writing surface is approximately 30 inches by 40 inches, and the thickness of the lightweight foam board is approximately one-quarter inch thick. The lightweight foam core board 20 is preferably selected to be from 23 to 49 inches long, from 23 to 49 inches tall and from one-eighth of an inch to one-half inches thick.

Note that in FIG. 1, a piece of the first end portion 46 is cutaway to show the external edge 26 of the lightweight foam board 20.

To make a foam core board 20 suitable for use as a two sided dry erase board apparatus 10, it must be coated on both the first and second sides 22, 24, with a suitable dry erase film material 32, 34. This is accomplished by applying a layer poly-film, such as oriented polypropylene (OPP) type film, between about two mils to six mils thick, on both the first and second sides 22, 24 of the lightweight foam core board 20. This thin film 32, 34 can be applied using either a thermal lamination application process, an adhesive based application process, or by other application methods known in the art.

Another method of coating the opposing first and second sides 22, 24 of the dry erase foam board 20 is by applying a sprayable liquid layer of OPP with an airbrush, or by other known spray or roller means to both the first and second sides 22,24 of the lightweight foam board 20.

The external edges 26 of the lightweight dry erase board 20 are then covered with a lightweight frame assembly 40, which overlaps the external edges 26 of the lightweight foam board 20. The lightweight frame assembly 40 serves several purposes. First, it provides a finished edge for the lightweight foam board 20, which improves its appearance. Second, because the lightweight foam board 20 is somewhat brittle, and can be easily damaged, the lightweight frame assembly 40 strengthens the edges and ends of the two sided dry erase board apparatus 10. Third, the lightweight frame assembly 40 greatly increases the rigidity of the lightweight foam board 20, enabling the use of thinner foam material.

The lightweight frame assembly 40 also protects the first and second film layers 32, 34 from inadvertently pealing away from the lightweight foam board 20 during use.

FIG. 1 shows a perspective view of the first side 22 of the dry erase board apparatus 10. It shows the first side 22 surrounded by the lightweight frame assembly 40. The lightweight frame assembly 40 includes a U-shaped top frame portion 42, a U-shaped bottom frame portion 44, a first U-shaped end frame portion 46, and a second U-shaped end frame portion 48. Each of the U-shaped frame portions 42, 44, 46, 48 includes a slot sized to closely receive a respective end 26 of the foam core board therein.

As shown in cross sectional view in FIG. 3, the lightweight frame assembly 40 preferably has a larger external portion 56, with a substantially smaller, internal portion 58. The lightweight foam board 20, with first and second dry erase poly-film layers 22, 24 secured thereto, is received within the U-shaped slot provided on the internal portion 58, and secured thereto with a suitable fastening means, such as with glue, or by other known securement means. The lightweight frame assembly 40 may be made of metal, plastic, or other suitable materials. The lightweight frame assembly 40 may be painted or coated, or molded in a similar or contrasting color to suit the preference of the user.

FIG. 1 also shows frame mounting clip(s) 50 that allows the dry erase board apparatus 10 to be suspended from above, or mounted upon a suitable vertical surface (not shown). These frame mounting clips 50 are preferably snapped onto and slidably received upon the top side portion 42 frame assembly 40. At least one frame mounting clip 50 can thus be spaced as needed along the top frame portion 42, to suit the user's needs. A boss 53 extends above the top frame portion, and has an aperture 52 extending through the boss 53 in each of the frame mounting clips 50. The aperture 52 is provided for ease of releasably securing the dry erase board apparatus 10 to a suitable wall surface or hung from above, with a suitable fastener means 54.

The frame mounting clips 50 may be made of metal, plastic, wire, or other suitable materials. The frame mounting clips 50 may be painted or coated, or molded in a similar or contrasting color to suit the preference of the user.

FIG. 1 also shows a marker tray 60. The marker tray 60 includes a pair of tray mounting clips 62 that extend downward from the marker tray 60. The tray mounting clips 62 snap onto the bottom frame portion 44 to releasably secure the marker tray 60 to the lower frame member. This marker tray 60 is removable so that the marker tray 60 can be easily removed and reinstalled on the dry erase board apparatus 10, when the dry erase board apparatus 10 is turned to the second side 24, for further use.

Thus, the marker tray 60 can be snapped off the bottom frame portion 44, the dry erase board apparatus 10 turned around, and the marker tray 60 snapped back on to the bottom frame portion 44, in only a few seconds. Alternately, the marker tray 60 can be left off the dry erase board apparatus 10 if the dry erase board apparatus 10 is going to be turned frequently, or supported upon a wall.

The marker tray 60 may be made of metal, plastic, or other suitable materials. The marker tray may be extruded, molded or otherwise formed to suit its intended purpose. Preferably, the marker tray 60 has multiple ridges and groves 66 extending parallel to the lightweight foam board 20, to better hold at least one marker 68 thereon. The marker tray 60 may be painted or coated, or molded in a similar or contrasting color to suit the preference of the user.

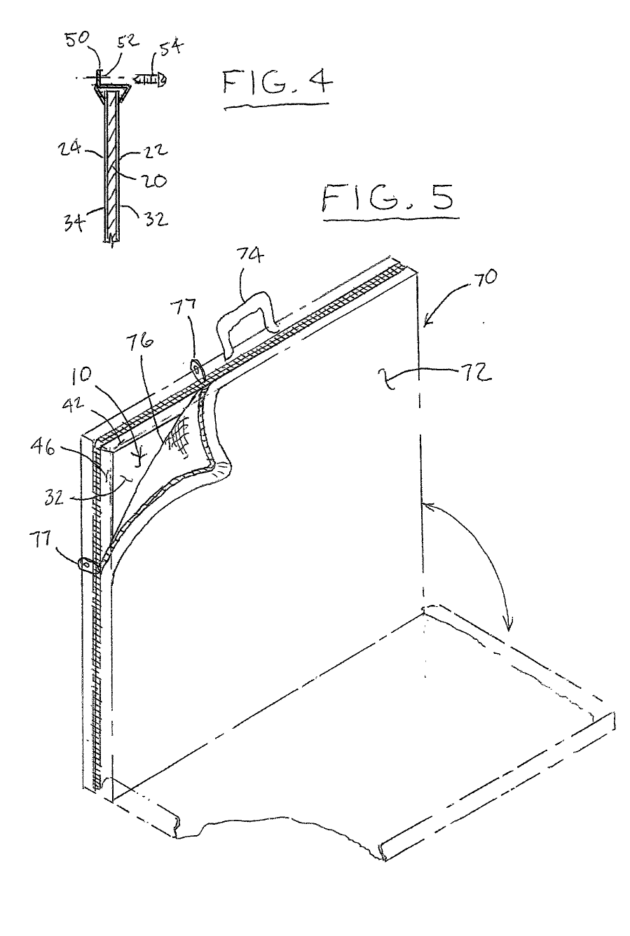

As shown in FIG. 4, a suitable pliable cover 70 may be used to cover the dry erase board apparatus 10 for ease of transport and storage. Preferably, the cover 70 is made of a pliable cloth, fabric or plastic sheet material 72. A handle 74 is preferably secured to the pliable fabric material 72 for ease of transport. A suitable opening 76 is preferably provided for ease of inserting or removing the dry erase board apparatus from the pliable cover 70. A closure means 77 is preferably provided to secure the opening 76 during transport or storage. Any known closure means 77, such as Velcro, zippers, buttons, clasps, straps, etc. may be used. The pliable cover 70 is shown partially closed about the dry erase board apparatus 10 in solid line in FIG. 5, and fully opened in dashed line in FIG. 5.

Thus, the dry erase board apparatus 10 may be easily transported to its intended location, protected by the cover 70. To use, the dry erase board apparatus 10 is removed from the cover 70 through opening 76, and placed upon a suitable horizontal planar surface, such as a table (not shown).

The enlarged external portion 56 of the bottom frame portion 44 is sized to support the dry erase board 10 in an upright position for presentation purposes. Indicia 80, such as words, numbers, drawings, etc. may be marked upon both the first side 22 and second side 24 of the dry erase board apparatus 10 with a suitable marker 68, or with multiple markers 68 having different colors. The indicia 80 may be previously placed upon the first and second sides 22, 24 of the dry erase board apparatus, or may be marked upon the first and second sides during the presentation. Because both first and second sides of the dry erase board apparatus 10 may be used, twice the indicia 80 may be presented during a demonstration, when compared with dry erase boards having only one usable dry erase side.

Alternately, the dry erase board apparatus 10 may be placed upon a wall, or hung from above, with suitable fasteners 54. When the first side 22 of the dry erase board apparatus is filled with indicia 80, the dry erase board apparatus 10 may be turned over to present the second side 24 of the dry erase board apparatus 10.

The marker tray 60 is useful for placing markers 68 when not in use, for easy access. The marker tray 60 may be easily removed from the first side 22 and moved to the second side 24 of the dry erase board apparatus 10 to suit the needs of the user.

The dry erase board apparatus 10 disclosed herein, is lightweight, easy to transport and store, and the two sided dry erase board 20 provides twice the space for indicia 80 as previously available for a single sided dry erase board of a given size.

Although a preferred embodiment has been disclosed by the specification and drawings provided herein, it should be understood that many changes and modifications may be made without departing from the scope of this disclosure, or from the scope of the following claims.

I claim:

1. A two sided dry erase board apparatus, comprising
a) a foam core board having a first side and a second side parallel to said first side, a top end, a bottom end parallel to said top end, a first end and a second end parallel to said first end;
b) a first dry erase poly-film layer secured to the first side of the foam core, and a second dry erase poly-film layer secured to the second side of the foam core, enabling a user to mark on both sides of the foam core board;
c) a frame assembly having a U-shaped top frame portion, a U-shaped bottom frame portion, a U-shaped first end frame portion and a U-shaped second end frame portion, each U-shaped frame portion having a slot extending the length of each of the frame portions, said slot sized to closely receive a respective end of the foam core therein; and
d) a means to secure the respective slotted frame portions to the respective ends of the foam core to form a protective frame around the ends of the foam core to strengthen and protect the ends of the foam core board.

2. The two sided dry erase board apparatus of claim 1, wherein at least one frame mounting clip is sized to engage the top frame portion, said frame mounting clip with a boss extending above the top frame portion, said frame mounting clip having an aperture therethrough, said aperture sized to receive a suitable fastening means therethrough, to releasably secure the dry erase board to a wall or ceiling.

3. The two sided dry erase board apparatus of claim 1, wherein a marker tray is releasably secured to the dry erase board on one of the first and second sides of the foam core board, in proximity to the bottom frame portion, said marker tray extending at a right angles to said dry erase board, in substantially parallel spaced relation to the bottom frame portion.

4. The two sided dry erase board apparatus of claim 3, wherein the marker tray has multiple grooves extending parallel to the lightweight foam board, to better hold at least one marker thereon.

5. The two sided dry erase board apparatus of claim 1, wherein the size of the dry erase board is selected to be from 23 to 49 nine inches long, from 23 to 49 inches tall and from one-eighth of an inch to one half inch thick.

6. The two sided dry erase board apparatus of claim 1, wherein the dry erase poly-film layer is oriented polypropylene type film, from two mils to six mils thick.

7. The two sided dry erase board apparatus of claim 1, wherein the dry erase poly film layer is secured to the lightweight foam board by at least one of: a thermal lamination application process, an adhesive based application process, and a sprayable liquid layer process.

8. The two sided dry erase board apparatus of claim 1, wherein at least the bottom frame portion has a larger external portion suitably sized to support the dry erase board apparatus in an upright position upon a planar surface.

9. The two sided dry erase board apparatus of claim 1, wherein a pliable cover is sized to receive the dry erase board apparatus through an opening therein, and said pliable cover is selectively opened and closed about the dry erase board with a suitable closure means.

10. A two sided dry erase board apparatus, comprising
a) a foam core board having a first side and a second side parallel to said first side, a top end, a bottom end parallel to said top end, a first end and a second end parallel to said first end;
b) a first dry erase poly-film layer secured to the first side of the foam core, and a second dry erase poly-film layer secured to the second side of the foam core, enabling a user to mark on both sides of the foam core board;
c) a frame assembly having a U-shaped top frame portion, a U-shaped bottom frame portion, a U-shaped first end frame portion and a U-shaped second end frame portion, each U-shaped frame portion having a slot extending the length of each of the frame portions, said slot sized to closely receive a respective end of the foam core therein; and
d) a means to secure the respective slotted frame portions to the respective ends of the foam core to form a protective frame around the ends of the foam core to strengthen and protect the ends of the foam core board;
e) a pliable cover is sized to receive the dry erase board apparatus through an opening therein, and said pliable cover is selectively opened and closed about the dry erase board with a suitable closure means; and
f) a marker tray is releasably secured to the dry erase board in proximity to the bottom frame portion, said marker tray extending at a right angle to said dry erase board, in substantially parallel spaced relation to the bottom frame portion.

11. The two sided dry erase board apparatus of claim 10, wherein at least one frame mounting clip is sized to be releasably secured to the top frame portion, said frame mounting clip with a boss extending above the top frame portion, said frame mounting clip having an aperture therethrough, said aperture sized to receive a suitable fastening means therethrough, to releasably secure the dry erase board to a wall or ceiling.

12. The two sided dry erase board apparatus of claim 10, wherein the size of the dry erase board is selected to be from 23 to 49 nine inches long, from 23 to 49 inches tall and from one-eighth of an inch to one half inch thick.

13. The two sided dry erase board apparatus of claim 10, wherein the dry erase poly-film layer is oriented polypropylene type film, from two mils to six mils thick.

14. The two sided dry erase board apparatus of claim 10, wherein the dry erase poly film layer is secured to the lightweight foam board by at least one of: a thermal lamination application process, an adhesive based application process, and a sprayable liquid layer process.

15. The two sided dry erase board apparatus of claim 10, wherein at least the bottom frame portion has a larger external portion suitably sized to support the dry erase board apparatus in an upright position upon a planar surface.

16. claim 10. A two sided dry erase board apparatus, comprising
a) a foam core board having a first side and a second side parallel to said first side, a top end, a bottom end parallel to said top end, a first end and a second end parallel to said first end;
b) a first dry erase poly-film layer secured to the first side of the foam core, and a second dry erase poly-film layer secured to the second side of the foam core, enabling a user to mark on both sides of the foam core board;
c) a frame assembly having a U-shaped top frame portion, a U-shaped bottom frame portion, a U-shaped first end frame portion and a U-shaped second end frame portion, each U-shaped frame portion having a slot extending the length of each of the frame portions, said slot sized to closely receive a respective end of the foam core therein;
d) a means to secure the respective slotted frame portions to the respective ends of the foam core to form a protective frame around the ends of the foam core to strengthen and protect the ends of the foam core board;
e) a pliable cover is sized to receive the dry erase board apparatus through an opening therein, and said pliable cover is selectively opened and closed about the dry erase board with a suitable closure means;
f) a marker tray is releasably secured to the dry erase board in proximity to the bottom frame portion, said marker tray extending at a right angle to said dry erase board, in substantially parallel spaced relation to the bottom frame portion; and
at least one frame mounting clip is sized to be releasably secured to the top frame portion, said frame mounting clip with a boss extending above the top frame portion, said frame mounting clip having an aperture therethrough, said aperture sized to receive a suitable fastening means therethrough, to releasably secure the dry erase board to a wall or ceiling, and indicia is selectively placed on each of the first and second dry film layers secured to the first and second sides of the foam core board

17. The two sided dry erase board apparatus of claim 16, wherein at least the bottom frame portion has a larger external portion suitably sized to support the dry erase board apparatus in an upright position upon a planar surface.

18. The two sided dry erase board apparatus of claim 16, wherein the dry erase poly-film layer is oriented polypropylene type film, from two mils to six mils thick.

19. The two sided dry erase board apparatus of claim 16, wherein the size of the dry erase board is selected to be from 23 to 49 nine inches long, from 23 to 49 inches tall and from one-eighth of an inch to one half inch thick.

20. The two sided dry erase board apparatus of claim 16, wherein a handle is secured to the pliable cover for ease of transport and handling.
